(19) United States
(12) Patent Application Publication
(10) Pub. No.: US 2015/0197963 A1
(43) Pub. Date: Jul. 16, 2015

(54) TURNTABLE LOCK

(71) Applicant: SINOXLOCK (KUNSHAN) CO., LTD., Kunshuan (CN)

(72) Inventor: Mao-Yi CHEN, Kunshuan (CN)

(73) Assignee: SINOXLOCK (KUNSHAN) CO., LTD., Kunshuan (CN)

(21) Appl. No.: 14/596,859

(22) Filed: Jan. 14, 2015

Related U.S. Application Data
(60) Provisional application No. 61/927,119, filed on Jan. 14, 2014.

(51) Int. Cl. E05B 37/00

(52) U.S. Cl. CPC E05B 37/00

(57) ABSTRACT

A turntable lock is provided. The turntable lock includes a casing and a turntable lock body. The turntable lock body includes a lock body and a restricting part. The lock body is rotatably disposed in the casing, wherein one face of the casing exposes the lock body. The lock body restricts the rotation of the turntable lock relative to the casing when the lock body is locked. The restricting part connects the lock body, wherein a first end of the restricting part extends out of the casing and forms a closed locking area on the outer surface of the casing when the turntable lock body is in a lock position.

### BACKGROUND OF THE INVENTION

1. Field of the Invention

The present invention generally relates to a turntable lock.

2. Description of the Prior Art

For a long time, padlocks are widely used in various devices and products that need to be secured. The products, such as cabinets, suitcases, travel bags and any electronic devices, use padlocks to avoid unauthorized people to open and take out stuff from the products. Tourists normally put a padlock on the suitcase to avoid things contained in the suitcase from being stolen during air, sea or land transportation.

When using a conventional padlock, one end of the hook of the padlock is pulled out from the lock casing to form a void between the lock casing and the end of the hook. After one part of the object to be locked is put into the space between the lock casing and the hook, the end of the hook that is pulled out from the lock body is inserted into the lock body to secure the padlock and the object together. The conventional padlock is unusable if there is not enough space for pulling out the hook from the lock casing.

### SUMMARY OF THE INVENTION

An object of the present invention is to provide a turntable lock, wherein the hook is not required to be pulled out from the lock casing when opening the turntable lock.

The turntable lock of the present invention includes a casing and a turntable look body. The turntable lock body includes a lock body and a restricting part. The lock body is rotatably disposed in the casing, wherein one face of the casing exposes the lock body. The lock body restricts the rotation of the turntable lock body relative to the casing when the lock body is locked. The restricting part connects the lock body, wherein a first end of the restricting part extends out of the casing and forms a closed locking area on the outer surface of the casing when the turntable lock body is in a lock position.

The lock body includes an engaging part. The movement of the engaging part is restricted when the lock body is locked and therefore restricts the rotation of the lock body relative to the casing. The restriction to the movement of the engaging part is released when the lock body is unlocked. The casing is a round disc in shape. The lock body is a round disc in shape.

The edge of the casing recesses to form a U-shape concave. The casing has a circular void exposing the lock body. The circular void and the U-shape concave are disposed on the same diameter of the casing in round disc shape. The first end of the restricting part extends out of the casing from one side of the U-shape concave and separably connects to the other side of the U-shape concave to form the closed locking area on the outer surface of the casing when the turntable lock body is in the lock position. A second end of the restricting part opposite to the first end is connected to the lock body,

The casing includes a rotation auxiliary disposed in the casing, the rotation auxiliary has a guiding groove disposed on the edge of the rotation auxiliary, the restricting part corresponds to the guiding groove and is movable along the guiding groove and between the inner surface of the casing and the edge of the rotation auxiliary.

The restricting part and the lock body are respectively a rack and a gear meet for each other; the lock body rotates to move the restricting part and makes the first end of the restricting part connect the outer surface of the casing to form the closed locking area.

### BRIEF DESCRIPTION OF THE DRAWINGS

FIG. 1 illustrates an embodiment of the present invention;

FIG. 2 illustrates an embodiment of the present invention, wherein the turntable lock body is in the lock position;

FIG. 3 illustrates an embodiment of the present invention, wherein the turntable lock body is in the half-unlock position;

FIG. 4 illustrates an embodiment of the present invention, wherein the turntable lock body is in the unlock position;

FIG. 5 illustrates an embodiment of the present invention, wherein the casing includes a rotation auxiliary; and

FIGS. 6A-6B illustrate another embodiment of the present invention, wherein the restricting part and the lock body are respectively a rack and a gear meet for each other.

### DETAILED DESCRIPTION OF THE PREFERRED EMBODIMENT

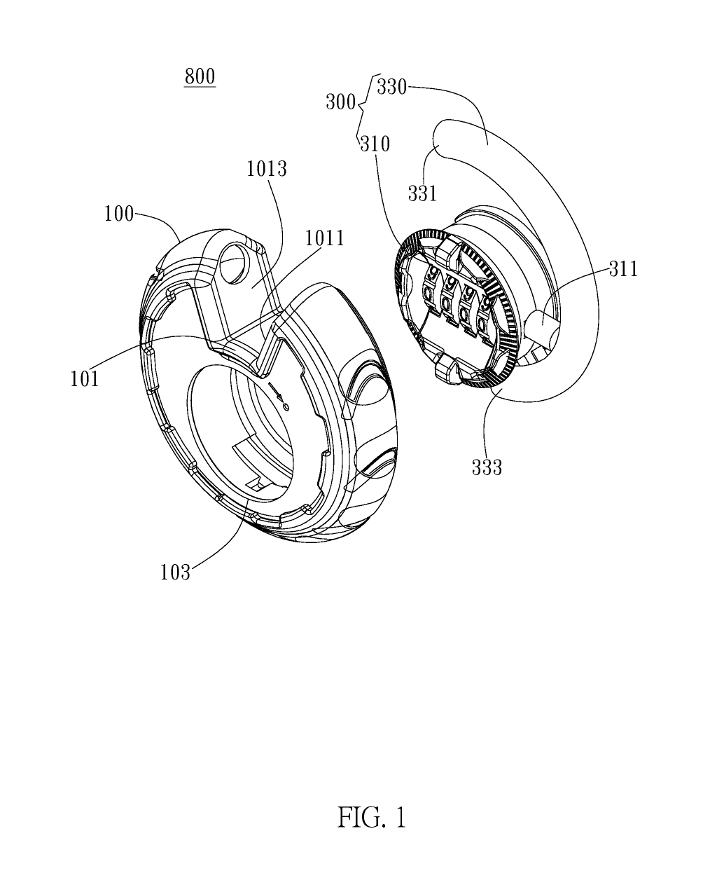

As an embodiment shown in FIG. 1, the turntable lock 800 of the present invention includes a casing 100 and a turntable lock body 300. The turntable lock body 300 includes a lock body 310 and a restricting part 330. The lock body 310 is rotatably disposed in the casing 100, wherein one face of the casing 100 exposes the lock body 310. The lock body 310 restricts the rotation of the turntable lock body 300 relative to the casing 100 when the lock body 310 is locked. More particularly, the lock body 310 includes an engaging part 311. The movement of the engaging part 311 is restricted when the lock body 310 is locked and therefore restricts the rotation of the lock body 310 relative to the casing 100. The restriction to the movement of the engaging part 311 is released when the lock body 310 is unlocked. The casing 100 is preferably a round disc in shape. The edge of the casing 100 recesses to form a U-shape concave 101. The lock body 310 is also preferably a round disc in shape. The casing 100 has a circular void 103 exposing the lock body 310. The circular void 103 and the U-shape concave 101 are disposed on the same diameter of the casing 100 in round disc shape. The restricting part 330 connects the lock body 310.

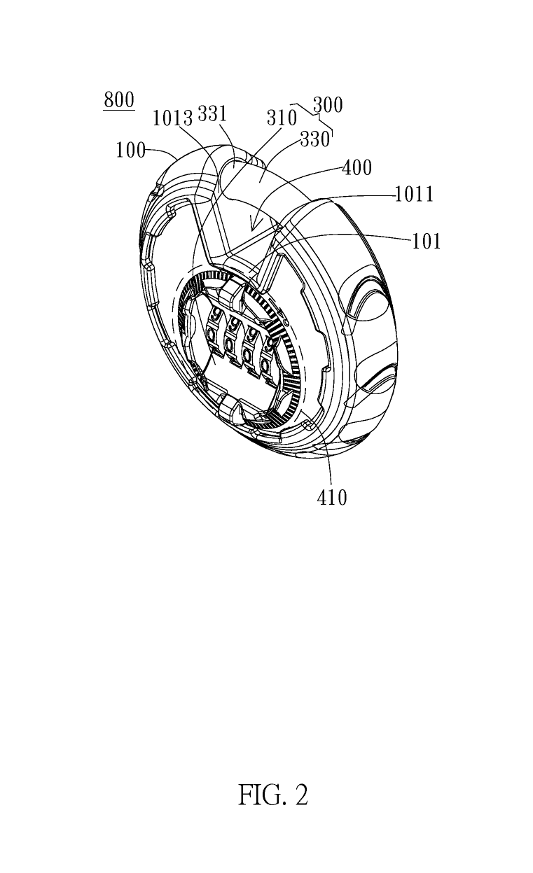

As an embodiment shown in FIG. 2, a first end 331 of the restricting part 330 extends out of the casing 100 and forms a closed locking area 400 on the outer surface of the casing 100 when the turntable lock body 300 is in a lock position 410. If the lock body 310 is locked, the movement of the engaging part 311 is restricted. The engaging part 311 therefore restricts the rotation of the lock body 310 corresponding to the casing 100. Hence, the turntable lock 800 is able to lock an object. More particularly, in the present embodiment, the first end 331 of the restricting part 300 extends out of the casing 100 from one side 1011 of the U-shape concave 101 and connects to the other side 1013 of the U-shape concave 101. The closed locking area 400 is substantially enclosed by the U-shape.

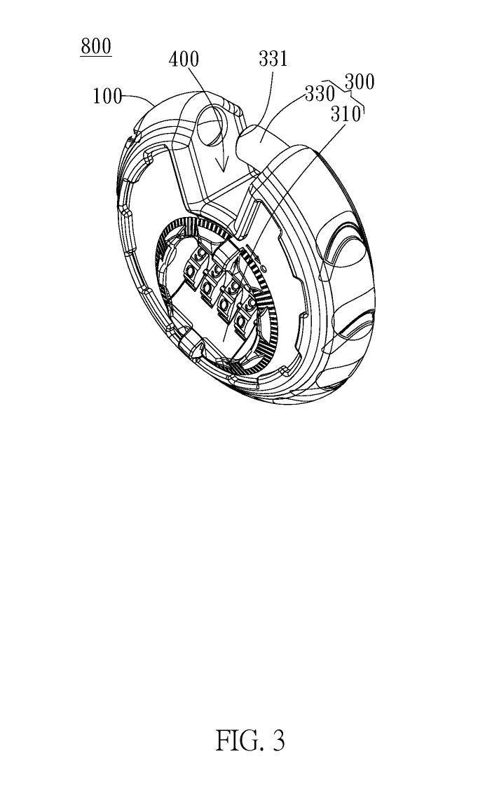

As an embodiment shown in FIG. 3, the lock body 310 releases the engaging part 311 when the lock body 310 is unlocked. At this time, a user can rotate the lock body 310, so that the lock body 310 rotates relative to the casing 100. Since the restricting part 330 connects the lock body 310, the lock body 310 and the restricting part 330 rotate relative to the casing 100 together when the lock body 310 rotates relative to the casing 100. Accordingly, the first end 331 leaves the outer surface of the casing 100 to release the closing state of the locking area 400.

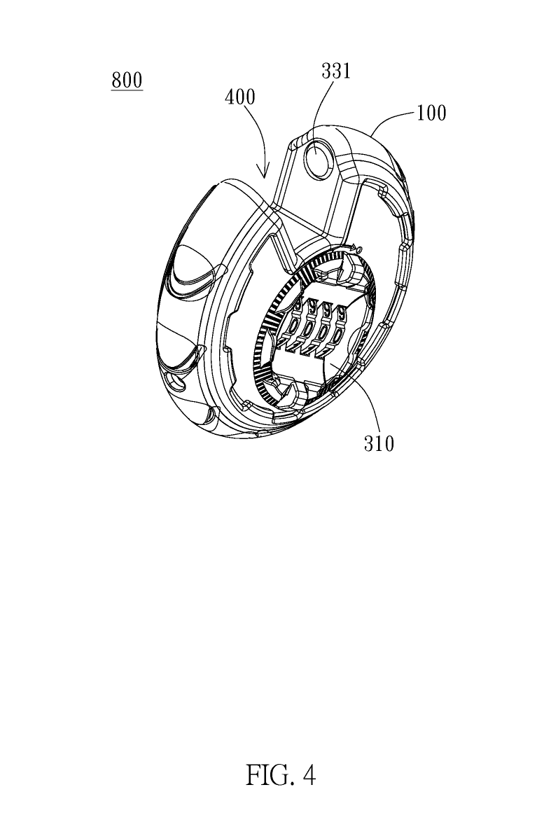

As an embodiment shown in FIG. 4, if the user keeps rotating the lock body 310, the turntable lock body 300 could be rotated to a full-unlock position. At this time, the first end 331 of the restricting part 330 preferably does not extend out of the casing 100 for the convenience of an object's entering the locking area 400.

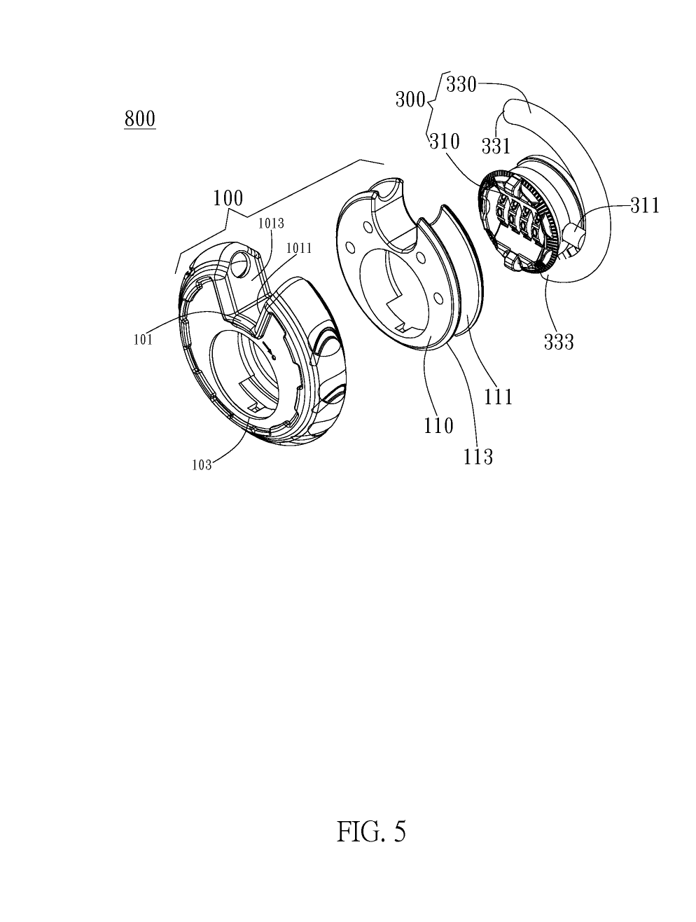

As an embodiment shown in FIG. 5, the casing 100 preferably includes a rotation auxiliary 110 disposed in the casing 100; the rotation auxiliary 110 has a guiding groove 111 disposed on the circumferential edge 113 of the rotation auxiliary 110: the restricting part 330 corresponds to the guiding groove 111 and is movable along the guiding groove 111 and between the inner surface of the casing 100 and the circumferential edge of the rotation auxiliary 110. Accordingly, the moving stability of the restricting part 330 can be enhanced.

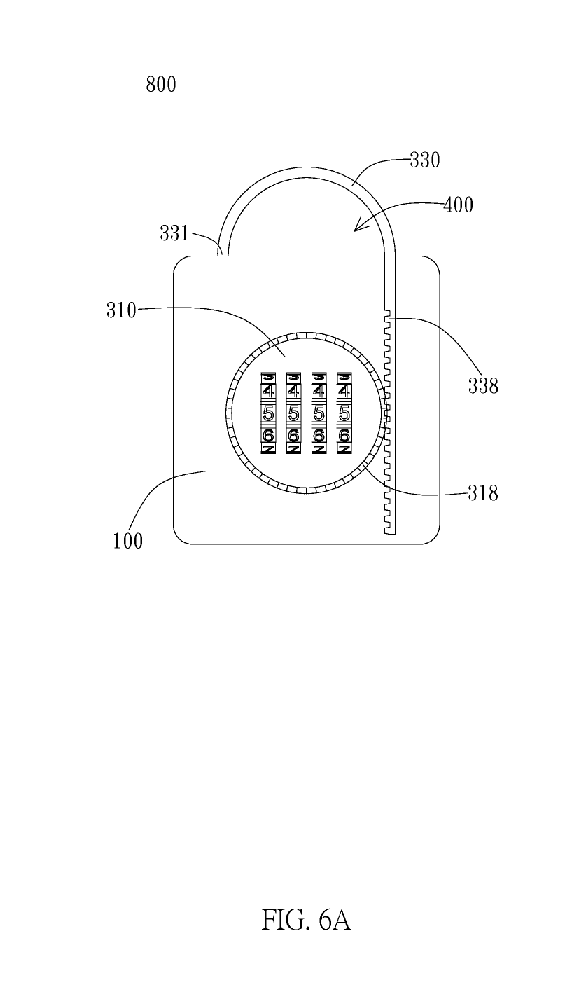

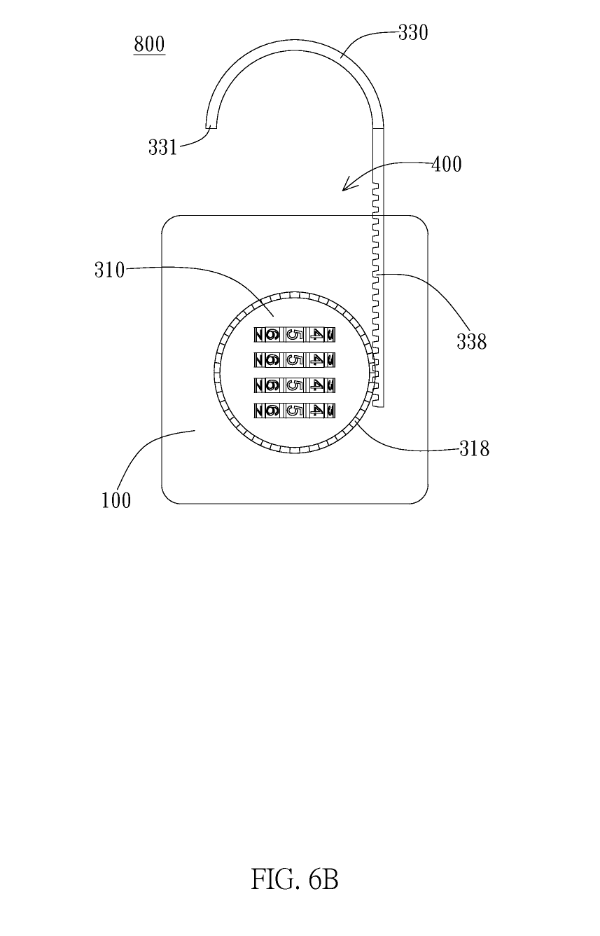

In the embodiments shown in FIGS. 1-5, a second end 333 (see FIGS. 1 and 5) of the restricting part 300 opposite to the first end 331 is connected to the lock body 310. In different embodiments, however, various changes could be made in accordance with the design, manufacture or usage requirements. As the embodiments shown in FIGS. 6A and 6B, the restricting part 330 and the lock body 310 are respectively a rack and a gear meet for each other. The user can rotate the lock body 310 to move the restricting part 330, making the first end 331 of the restricting part 330 connect the outer surface of the casing 100 to form a closed locking area 400, as shown in FIG. 6A, or making the first end 331 of the restricting part 330 leave the outer surface of the casing 100 to release the closing state of the locking area 400, as shown in FIG. 6B.

In the above embodiments, the lock bodies are preferably combination locks. In other embodiments, however, a key lock or other types of lock could be used.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed

1. A turntable lock, comprising:
a casing; and
a turntable lock body, including;
a lock body rotatably disposed in the casing, wherein one face of the casing exposes the lock body, wherein the lock body restricts the rotation of the turntable lock body relative to the casing when the lock body is locked; and
a restricting part connecting the lock body, wherein a first end of the restricting part extends out of the casing and forms a closed locking area on an outer surface of the casing when the turntable lock body is in a lock position.

2. The turntable lock of claim 1, wherein the lock body includes an engaging part, wherein:
the movement of the engaging part is restricted when the lock body is locked and therefore restricts the rotation of the I ck body relative to the casing; and
the restriction to the movement of the engaging part is released when the lock body is unlocked.

3. The turntable lock of claim 1, wherein the casing is a round disc in shape.

4. The turntable lock of claim , wherein the lock body is a round disc in shape.

5. The turntable lock of claim 3, wherein an edge of the casing recesses to form a U-shape concave.

6. The turntable lock of claim 5, wherein the casing has a circular void exposing the lock body.

7. The turntable lock of claim 6, wherein the circular void and the U-shape concave are disposed on the same diameter of the casing in round disc shape.

8. The turntable lock of claim 5, wherein the first end of the restricting part extends out of the casing from one side of the U-shape concave and connects to the other side of the U-shape concave to form a closed locking area on the outer surface of the casing when the turntable lock body is in the lock position.

9. The turntable lock of claim 1. wherein a second end of the restricting part opposite to the first end is connected to the lock body.

10. The turntable lock of claim 1, wherein the casing includes a rotation auxiliary disposed in the casing, the rotation auxiliary has a guiding groove disposed on an edge of the rotation auxiliary, the restricting part corresponds to the guiding groove and is movable along the guiding groove and between the inner surface of the casing and the edge of the rotation auxiliary.

11. The turntable lock of claim 1, wherein the restricting part and the lock body are respectively a rack and a gear meet for each other, the lock body rotates move the restricting part and makes the first end of the restricting part connect the outer surface of the casing to form the closed locking area.
